(19) United States
(12) Patent Application Publication
(10) Pub. No.: US 2016/0075883 A1
(43) Pub. Date: Mar. 17, 2016

(54) METHODS OF FABRICATING SUPERHYDROPHOBIC, OPTICALLY TRANSPARENT SURFACES

(71) Applicant: The Ohio State University, (US)

(72) Inventors: Daniel R. Ebert, Alexandria, VA (US); Bharat Bhushan, Powell, OH (US)

(73) Assignee: The Ohio State University, Columbus, OH (US)

(21) Appl. No.: 13/870,662

(22) Filed: Apr. 25, 2013

(51) Int. Cl. C09D 5/00; B05D 5/08; B05D 7/02; C08J 7/04; C09D 183/04; C09D 7/12; C09D 7/00; C03C 17/00; B05D 3/00

(52) U.S. Cl. CPC C09D 5/00; C03C 17/009; C03C 17/001; B05D 5/08; B05D 7/02; B05D 3/007; C09D 183/04; C09D 7/1225; C09D 7/001; C08J 7/047; C03C 2217/476; C03C 2217/478; C03C 2217/76; C03C 2218/11; C03C 2218/32; C08J 2333/12; C08J 2369/00; C08J 2483/04

(57) ABSTRACT

Methods and solutions for fabricating a superhydrophobic, optically transparent surface on a substrate. A dip coating technique is employed in which a solution comprising hydrophobic nanoparticles, a resin binder and a solvent is provided. The substrate is dipped and then withdrawn from the solution. As the substrate is withdrawn, a precursor coating of the solution is formed on a surface of the substrate. The solvent in the precursor coating is allowed to evaporate (is otherwise removed), immediately resulting in a superhydrophobic, optically transparent coating on the substrate surface. The hydrophobic nanoparticles can be metal oxide nanoparticles (such as SiO₂, ZnO, and ITO) that are surface functionalized to be hydrophobic. Substrate types include glass and polymer substrates such as PC and PMMA.

### STATEMENT REGARDING FEDERALLY FUNDED RESEARCH OR DEVELOPMENT

This invention was made with government support from the National Science Foundation, Grant Number CMMI-1000108. The government may have certain rights in the invention.

### BACKGROUND

Interest in superhydrophobic surfaces (defined as having a water contact angle (CA) greater than 150° and contact angle hysteresis (CAH) less than 10°) has grown rapidly in recent years due to unique characteristics such as self-cleaning, antifouling and fluid drag reduction. However, for applications such as self-cleaning windows, optical devices, and solar panels, high optical transparency is additionally required, as well as resistance to mechanical wear. For example, typical requirements for an automotive windshield are visible transmittance>90%, haze<1%, 10,000 cycles of wiper sliding, and 250 car wash cycles, the last two requirements representing 10 years of life.

A maximum CA of about 120° can be obtained for a nominally flat surface with a low surface energy coating. In order to produce a superhydrophobic surface, roughness is required. On a rough surface, a deposited water droplet will reside in either the Wenzel or Cassie-Baxter wetting regime. In the Wenzel regime, water fully penetrates roughness features, creating a continuous liquid-solid contact. In the Cassie-Baxter regime, the droplet rests on the peaks of roughness features, with air pockets filling the gaps in between. This air pocket formation leads to low CAH for self-cleaning ability, and thus in addition to roughness, a high liquid-air fractional area (f_{LA}) is important for superhydrophobic surfaces when self-cleaning is desired. However, the dual requirements of superhydrophobicity and transparency pose a challenge. The surface must be sufficiently rough to obtain high CA and low CAH, but the dimensions of the roughness features must be small enough to preserve high transmittance of light. It is usually suggested that the size of surface features should not exceed roughly one quarter of the wavelength of visible light (around 100 nm or less).

While glass is the most common optical material for lenses, architectural windows, etc., transparent polymers such as polycarbonate (PC) and poly(methyl methacrylate) (PMMA) are also of great engineering importance. PC and PMMA are used for wide-ranging applications such as aircraft canopies, bullet-proof windows, solar cell panels, laptop computer screens, and many high-performance optical, electronic and medical devices. SiO₂, ZnO, and ITO (indium tin oxide) thin films are of interest for varying applications. These three metal oxides have high transmittance for visible light due to low refractive indices (minimizing reflectance) and band gap wavelengths shorter than the visible range of 400-700 nm (minimizing visible-range absorption). SiO₂ in particular has extremely high visible transmittance. ZnO thin films can have a UV-protective effect, and have been shown to reduce photodegradation of PC. When doped with other metals such as AI or Ga, ZnO can also be used for transparent conducting films. ITO is the most commonly used material for transparent conducting films due to its combination of high visible transmittance and low electrical resistivity. In addition, these particles have high hardness. Thus, SiO₂, ZnO, and ITO nanoparticles would seem to be suitable candidates for wear-resistant, transparent, superhydrophobic surfaces.

In the case of glass, nanostructuring has generally been achieved through dip coating or spin coating of nanoparticles. For polymers, plasma etching techniques have also commonly been used. Several studies have reported optical transmittance approaching 100%, with a few even reporting enhanced transmittance compared to the uncoated substrate due to an antireflective effect. However, many of the so-created surfaces required post-fabrication treatment with fluorosilane or other low surface energy substance to achieve superhydrophobicity. In some cases, CAH and/or tilt angle (TA), which are important for self-cleaning ability, are not reported. In many cases, mechanical wear experiments are either absent or lack quantitativeness. Relatively few studies have used polymer substrates as compared to glass. Notably, SiO₂ nanoparticles have been the overwhelming favorite to provide a nanostructure, while studies using other particles such as ZnO have been less common. The use of ITO nanoparticles to create superhydrophobic surfaces has not been found in the literature. In order to capitalize on the unique properties that different nanoparticles offer, as well as expand potential applications, a need exists for fabrication techniques that are suitable for a variety of nanoparticles and optical substrates.

### SUMMARY

Aspects of the present disclosure relate to a method for fabricating a superhydrophobic, optically transparent surface on a substrate. In some embodiments, a dip coating technique is disclosed in which a solution comprising hydrophobic nanoparticles, a resin binder and a solvent is provided. The substrate is dipped and then withdrawn from the solution. As the substrate is withdrawn, a precursor coating of the solution is formed on a surface of the substrate. The solvent in the precursor coating is allowed to evaporate (or is otherwise removed), immediately resulting in a superhydrophobic, optically transparent coating on the substrate surface.

In some embodiments, methods and solutions of the present disclosure are useful for creating a superhydrophobic, optically transparent surface or coating on multiple different substrate types including glass and polymer substrates such as polycarbonate (PC) and polymethyl methacrylate (PMMA). The hydrophobic nanoparticles can be metal oxide nanoparticles (such as SiO₂, ZnO, and ITO) that are surface functionalized to be hydrophobic. Optional solvents useful with the methods and solutions of the present disclosure include tetrahydrofuran (THF), or mixtures of THF and other solvents such as isopropyl alcohol (IPA). With solution concentrations and dip/withdrawal speeds of the present disclosure, the desired superhydrophobic transparent coating is complete immediately following evaporation of the solvent, and no chemical post-treatment of the prepared surfaces is required to render them superhydrophobic.

As hydrophobized nanoparticles are often available commercially, the elimination of the need for surface post-treatment simplifies the fabrication process and reduces costs, particularly for substrate surfaces with large areas. In addition, for many polymer substrates, some post-treatment techniques such as vapor deposition or plasma may be undesirable. The surface coatings provided by the methods and solutions of the present disclosure are characterized as being superhydrophobic in terms of wettability (CA/CAH) and optically transmissive in the visible spectrum (e.g., at least 90% transmissive to visible light). Further, wear resistance experiments using an atomic force microscope and a water jet apparatus to examine sliding wear and impingement of water jet confirm that the surface coatings of the present disclosure are wear resistant.

### BRIEF DESCRIPTION OF THE DRAWINGS

FIG. 1 is a simplified side view of an article fabricated in accordance with principles of the present disclosure;

FIG. 2 is a flow diagram of methods of forming a superhydrophobic transparent coating on a substrate surface in accordance with principles of the present disclosure;

FIG. 3 is a simplified side view of a portion of the method of FIG. 2;

FIG. 4 is a schematic illustration of hydrophobization of a generic metal oxide surface with octadecylphosphonic acid (ODP);

FIG. 5 schematically illustrates a water jet wear resistance testing system;

FIG. 6 shows SEM micrographs of examples of SiO₂, ZnO, and ITO nanoparticle coatings on glass substrates at two magnifications each;

FIG. 7 is a bar graph illustrating contact angle (CA), contact angle hysteresis (CAH), and visible transmittance for samples prepared in accordance with principles of the present disclosure, including SiO₂, ZnO, and ITO nanoparticles on glass, polycarbonate, and PMMA substrates, with error bars representing + or −1 standard deviation;

FIG. 8 are graphs illustrating transmittance spectra in the visible range for samples prepared in accordance with principles of the present disclosure, including SiO₂, ZnO, and ITO nanoparticle coatings on glass, polycarbonate, and PMMA substrates, with data representing transmittance as a percentage of the transmittance of the uncoated substrate;

FIG. 9 shows photographs of water droplets deposited on glass, polycarbonate, and PMMA with ITO nanoparticle coatings, and a Goniometer image of a water droplet on a glass substrate with ITO nanoparticle coating prepared in accordance with principles of the present disclosure;

FIG. 10 are surface height maps and surface profiles of samples prepared in accordance with principles of the present disclosure before and after AFM wear experiments; and

FIG. 11 shows graphs illustrating results of a water pressure wearing test performed on samples prepared in accordance with principles of the present disclosure, including contact angle (CA) and contact angle hysteresis (CAH) as a function of water pressure.

### DETAILED DESCRIPTION

Aspects of the present disclosure relate to methods for forming a superhydrophobic, optically transparent coating on a substrate, and solutions from which the coatings can be formed. With this in mind, FIG. 1 is a simplified representation of an article 10 fabricated in accordance with principles of the present disclosure. The article 10 includes a substrate 12 and a superhydrophobic, optically transparent coating 14 formed on and bonded to at least one surface 16 of the substrate 12. As described below, the substrate 12 can assume a variety of forms, and in some embodiments is glass or a polymer substrate. Polymer substrates useful with the present disclosure include transparent polymer substrates such as polycarbonate (PC) and polymethyl methacrylate (PMMA) to name but a few. Regardless, methods in accordance with principles of the present disclosure generate the superhydrophobic, optically transparent coating 14 via a dip coating technique as described below. The superhydrophobic, optically transparent coating 14 is a composite of hydrophobic nanoparticles 18 (a size of which are greatly exaggerated in the drawing of FIG. 1 for purposes of clarification) held to the substrate surface 16 by a binder 20 (referenced generally). In general terms, at least a portion of some of the nanoparticles 18 are maintained beyond a thickness of the binder 20 to render the coating 14 superhydrophobic. As used throughout the present disclosure, “superhydrophobic” is in reference to a surface exhibit a water contact angle (CA) of greater than 150° and a contact angle hysteresis (CAH) of less than 10°. The term “transparent” is in reference to a surface that is at least 90% transmissive to visible light.

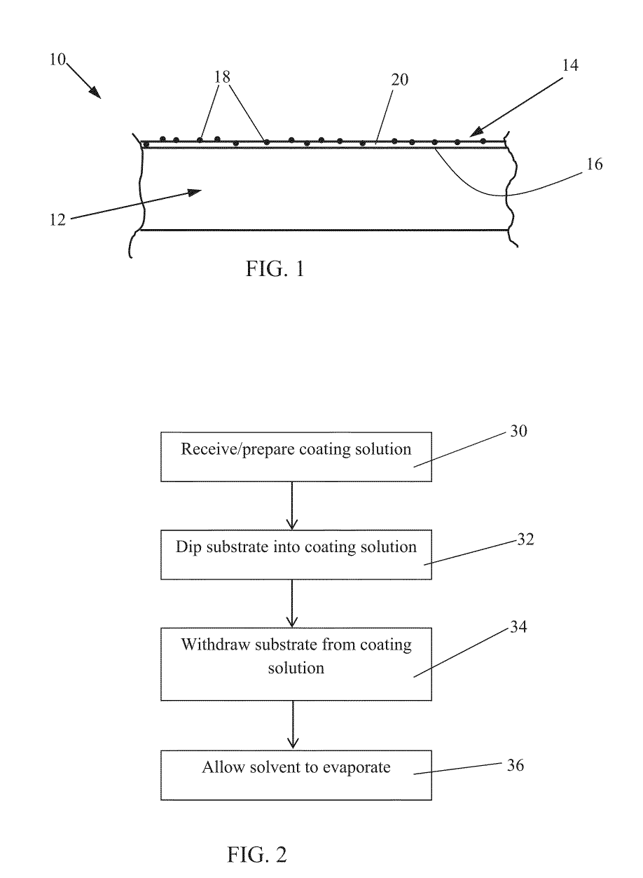

With reference to FIG. 2, methods of the present disclosure include receiving (or preparing) a coating solution at step 30. The solution generally consists of hydrophobic nanoparticles, a binder resin, and a solvent.

The hydrophobic nanoparticles can assume various forms, and in some embodiments are metal oxide particles. As a point of reference, many metal oxide particles are inherently hydrophilic. These particles can be hydrophobized using silanes or other treatment before combining into the solution. For metal oxide particles (such as SiO₂, ZnO, or ITO), phosphonic acids (such as octadecylphosphonic acid (ODP)) can be used to easily modify the particle surface to be hydrophobic.

Functionalize hydrophobic metal oxide nanoparticles useful with the methods and coating solutions of the present disclosure include functionalized SiO₂, ZnO, and ITO. The metal oxide nanoparticles can have an average particle size in the nanoscale range. In some embodiments, the metal oxide nanoparticles provided in the coating solutions of the present disclosure are surface-functionalized SiO₂ nanoparticles having an average particle size in the range of 1-100 nm, alternatively in the range of 20-80 nm, and optionally on the order of 55 nm (+ or −15 nm). In other embodiments, the metal oxide nanoparticles provided in the coating solutions of the present disclosure are surface-functionalized ZnO nanoparticles having an average particle size in the range of 1-150 nm, alternatively in the range of 20-130 nm, and optionally on the order of 70 nm (+ or −30 nm). In yet other embodiments, the metal oxide nanoparticles provided in the coating solutions of the present disclosure are surface-functionalized ITO nanoparticles having an average particle size in the range of 1-100 nm, alternatively in the range of 20-80 nm, and optionally on the order of 45 nm (+ or −25 nm). In other embodiments, the hydrophobic nanoparticles can be comprised of other materials and/or have other average particle sizes.

The resin binder component of the coating solutions of the present disclosure can assume various forms, and in some embodiments is epoxy or silicone. The resin binder is generally formulated to bind the hydrophobic nanoparticles to the surface of the substrate being coated. In some embodiments, a useful resin binder is methylphenyl silicone resin, as it has low surface energy (˜25 dyne/cm), dissolves in a variety of solvents, and has high hardness (˜1.3 GPa). Low surface energy for the resin binder may improve superhydrophobicity and low roll-off angle of surfaces, as gaps between particles will contain a hydrophobic resin layer. In addition, methylphenyl silicone resin may improve dispersibility in solution for some hydrophobic nanoparticles.

The solvent component of the coating solutions of the present disclosure can assume various forms, and optionally exhibits a high evaporation rate for uniform coatings. Alcohols (such as ethanol or isopropyl alcohol (IPA)) may be less preferred as they may not provide an adequate evaporation rate, and additionally cannot dissolve epoxy or silicone resin binders. Tetrahydrofuran (THF) evaporates very rapidly and evenly from substrates after dip coating, leaving uniform coatings, and easily dissolves epoxy and silicone resins. However, THF dissolves many polymer substrates of interest to methods of the present disclosure, such as polycarbonate (PC) and polymethyl methacrylate (PMMA). In some embodiments, the solvent component is a mixture of THF and an alcohol such as IPA, with the alcohol component being at least 51% (by volume) of the mixed solvent. For example, in some embodiments, solvents of the coating solutions of the present disclosure are a mixture of 30-49% THF and 51-70% IPA (or other alcohol) by volume; alternatively approximately 40%/60% THF/IPA by volume (+ or −5%). It has surprisingly been found that when THF was mixed with IPA at a ratio of approximately 40%/60% THF/IPA by volume, PC and PMMA substrates showed no visible damage after 1 minute immersed in solution. In addition, a 40%/60% THF/IPA mixture evaporated quickly and evenly enough for uniform coatings. For glass substrates, however, pure THF may be used.

With the coating solutions of the present disclosure, a concentration of the hydrophobic nanoparticles in the solvent can vary, for example as a function of the materials employed as the hydrophobic nanoparticles. For example, with embodiments in which the hydrophobic nanoparticles are surface functionalize SiO₂ nanoparticles, a concentration of the SiO₂ nanoparticles in the solvent can be in the range of 1-20 mg/mL, alternatively in the range of 5-15 mg/mL, and optionally about 10 mg/mL (+ or −1 mg/mL). With embodiments in which the hydrophobic nanoparticles are surface functionalize ZnO nanoparticles, a concentration of the ZnO nanoparticles in the solvent can be in the range of 5-65 mg/mL, alternatively in the range of 25-45 mg/mL, and optionally about 35 mg/mL (+ or −1 mg/mL). With embodiments in which the hydrophobic nanoparticles are surface functionalize ITO nanoparticles, a concentration of the ITO nanoparticles in the solvent can be in the range of 20-80 mg/mL, alternatively in the range of 40-60 mg/mL, and optionally about 50 mg/mL (+ or −1 mg/mL). It has surprisingly been found that too low a concentration can result in loss of superhydrophobicity in the resultant substrate surface coating, while too high of a concentration can result in visible agglomeration of particles on the substrate surface, thus negatively affecting transparency of the resultant substrate surface coating. In other embodiments, the concentration of hydrophobic nanoparticles in the solvent can have other values.

With the coating solutions of the present disclosure, a concentration of the resin binder in the solvent can vary, for example as a function of the materials employed as the resin binder. For example, with embodiments in which the resin binder is methylphenyl silicone resin, a concentration of the methylphenyl silicone resin in the solvent is in the range of 1-5 mg/mL, alternatively in the range of 2.75-4.75 mg/mL, optionally approximately 3.75 mg/mL (+ or −0.5 mg/mL). It has surprisingly been found that in the case of a silicone resin, a concentration significantly below these preferred levels can result in poor adherence of the hydrophobic nanoparticles to the substrate surface, whereas a concentration significantly above these preferred levels can result in loss of superhydrophobicity (likely due to the complete engulfing of particles in the resin layer).

With the above characteristics of the coating solution in mind, the substrate 12 is dipped into the coating solution at step 32. Prior to, or commensurate with this step, the coating solution can be subjected to sonification or other mixing.

At step 34, the substrate 12 is then withdrawn, in some embodiments immediately withdrawn, from the coating solution. The rate of withdrawal of the substrate 12 can be uniform or controlled, and is selected to create a substantially uniform coating of the coating solution on the substrate surface. For example, in some embodiments, the substrate 12 is withdrawn from the coating solution at a rate in the range of 5-15 cm/min, optionally approximately 10 cm/min (+ or −1 cm/min).

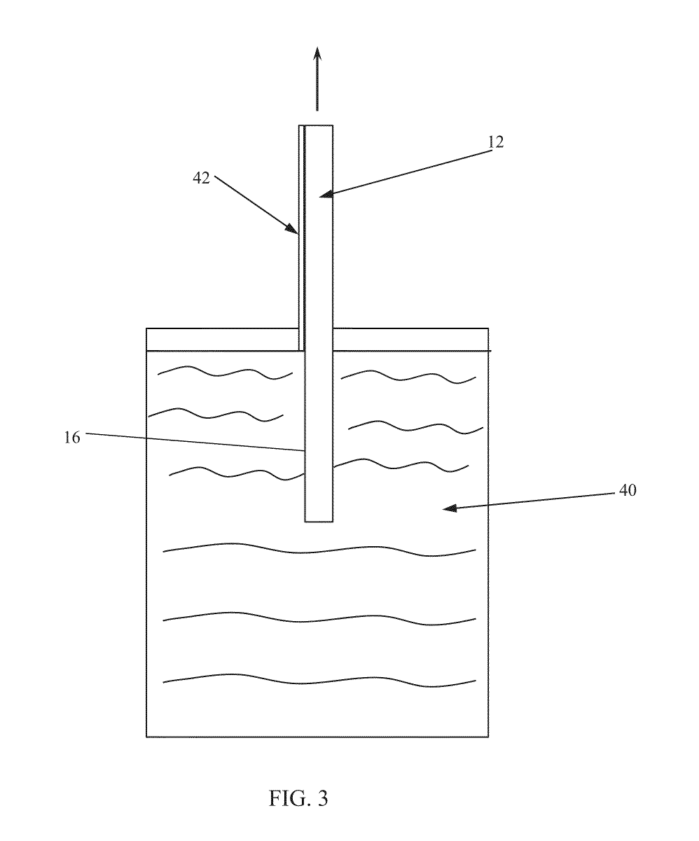

As generally reflected in FIG. 3, as the substrate 12 is continuously withdrawn from a volume 40 of the coating solution, a layer or coating 42 of the coating solution remains on at least the surface 16 (e.g., the resin binder component of the coating solution bonds or adheres to the surface 16). Because this initial layer or coating 42 (in existence immediately after withdrawal from the volume 40) includes at least some of the solvent component, the initial layer or coating 42 can be referred to as a precursor coating. With additional reference to FIG. 2, the solvent component of the precursor coating 42 is allowed to evaporate at step 36. In some embodiments, the coated substrate can be heated (e.g., at approximately 40° C. (+ or −5° C.) for approximately 10 minutes (+ or −5 minutes)) to remove any remaining solvent.

Immediately following evaporation or removal of the solvent, the precursor coating 42 transitions to the final, superhydrophobic, optically transparent coating 14 of FIG. 1. Formation of the superhydrophobic transparent coating 14 requires no chemical post-treatment or modification after completion of the dip coating steps 32-36 in accordance with methods of the present disclosure.

The superhydrophobic, optically transparent coatings 14 generated by methods and solutions of the present disclosure can have a thickness in the range of 50-150 nm, optionally approximately 100 nm (+ or −10 nm) in some embodiments. Further, the superhydrophobic, optically transparent coatings 14 of the present disclosure are highly wear resistant as described below.

### Examples

In the examples described below, superhydrophobic, transparent coated surfaces were formed on various substrate samples using methods and coating solutions of the present disclosure. Different hydrophobic nanoparticles and different substrates were employed for various ones of the examples surfaces. Contact angle, contact angle hysteresis, and optical transmittance were measured for samples using all particle-substrate combinations. Wear resistance testing was also performed.

Soda-lime glass (2.2 mm thick), polycarbonate (Lexan, SABIC Innovative Plastics, 2.4 mm thick), and PMMA (Optix, Plaskolite Inc., 2 mm thick) were used to create 1 cm×1 cm substrates. Silane-modified hydrophobic SiO₂ nanoparticles with average diameter of 55 nm (±15 nm) were obtained from Evonik Industries (AEROSIL RX 50). ZnO nanoparticles with average diameter of 70 nm (±30 nm) were obtained from Alfa Aesar (NanoTek Zinc Oxide). ITO nanoparticles (90:10 In₂O₃:SnO₂) of average diameter 45 nm (±25 nm) were obtained from US Research Nanomaterials (US3855 Indium Tin Oxide Nanopowder). Octadecylphosphonic acid (ODP) was purchased from Aldrich, and methylphenyl silicone resin was obtained from Momentive Performance Materials (SR355S Methylphenyl Silicone Resin).

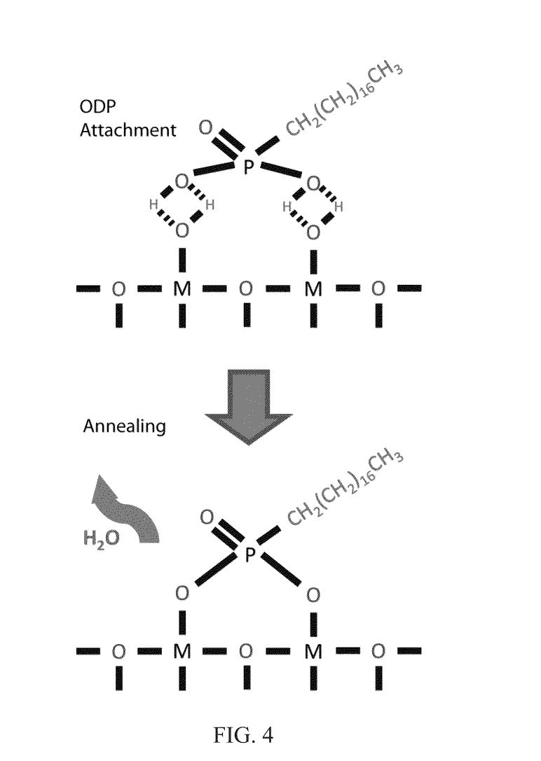

While the obtained SiO₂ particles were already silane-modified, the ZnO and ITO particles were not surface-modified as received. In order to hydrophobize them, they were treated in solution by octadecylphosphonic acid (ODP). ODP can be used to functionalize metal oxides from hydrophilic to hydrophobic. The process by which functionalization occurs is illustrated in FIG. 4. The exposed long-chain hydrocarbon tails of the ODP molecules result in a hydrophobic particle surface. Approximately 2 g of particles were added to a 100 mL ethanol solution with ODP concentration of 2 mM. The mixture was stirred vigorously for 10 min, covered, and left for 4 days at 20° C. The solvent was then removed by evaporation, and the particles were heated at 100° C. for 1 hour to improve ODP bonding and remove adsorbed water or remaining solvent.

Particles were dispersed in a 40%/60% THF/IPA (by volume) mixture to form the dip coating solution. While pure THF rapidly dissolves PC and PMMA resulting in complete loss of transparency, it was found that when THF concentration was kept below approximately 50% by volume in IPA, substrates could be dipped for over one minute without visible damage or loss of transparency. A dip coating solution of pure IPA, however, does not evaporate quickly or evenly enough to leave a homogeneous coating on the substrate. Optimal concentrations of nanoparticles in the solvent were found to be approximately 10 mg/mL for SiO₂ particles, 35 mg/mL for ZnO particles, and 50 mg/mL for ITO particles. Too low of a concentration resulted in loss of superhydrophobicity, while too high of a concentration resulted in visible agglomeration of particles on substrates, substantially reducing transparency.

The nanoparticles were added to 30 mL of the THF/IPA solvent in a 100 mL glass beaker and sonicated for 4 min with a Branson Sonifier 450A (20 kHz frequency at 35% amplitude). Then, 150 mg of methylphenyl silicone resin was added and the mixture was sonicated for an additional 4 min. In the case of the silicone resin, a concentration significantly below this optimal level resulted in poor adherence of the particles to the substrate. Concentration significantly above this level resulted in loss of superhydrophobicity, likely due to the complete engulfing of particles in the resin layer. In addition to ultimately acting to bind nanoparticles to the substrates, the silicone resin worked excellently as a dispersant in the dip coating solution. For ITO particles in particular, settling was noticeable within seconds when silicone resin was not added, but particles remained homogeneously dispersed with resin included. After sonication, approximately 10 mL of fresh solvent was added at 40%/60% THF/IPA ratio. Substrates were dipped into the solution and immediately removed at a speed of 10 cm/min. Coated samples were then heated at 40° C. for 10 min to remove any remaining solvent. The samples required no chemical post-treatment or modification after dip coating.

### Testing

For wettability measurements, water droplets of 5 μL, volume (˜1 mm radius) were deposited onto samples using a microsyringe. Reproducibility of all CA/CAH data is reported as (±Σ) as determined from measurement on five samples using a model 290-F4 Ramé-Hart goniometer (Ramé-Hart Inc., Succasunna, N.J.). Values for f_{LA} were estimated using SPIP™ imaging software (Image Metrology). Transmittance measurements were performed using an Ocean Optics USB400 spectrometer (Ocean Optics Inc., Dunedin, Fla.) with a 200 μm aperture width. All transmittance data is reported for a one-sided coating as a percentage of the transmittance of the uncoated substrate in the visible spectrum (400-700 nm).

To examine the wear resistance of the samples, wear experiments were performed using an AFM and water jet apparatus. In order to study sliding wear resistance, an established AFM wear experiment was performed with a commercial AFM (D3100, Nanoscope IIIa controller, Digital Instruments, Santa Barbara, Calif.). For wear experiments, investigation of single asperity contact is necessary to understand fundamental interfacial phenomena. An AFM tip can simulate single asperity contact for micro/nanostructured surfaces. Samples with SiO₂, ZnO, and ITO nanoparticles on glass substrates were worn using a borosilicate ball with a radius of 15 μm mounted on a rectangular Si(100) cantilever (k=7.4 N/m) in contact mode. Areas of 50×50 μm² were worn for 1 cycle at a load of 10 μN. To analyze the change in the morphology of the surfaces before and after the wear experiment, height scans of 100×100 μm² in area were obtained using a rectangular Si(100) tip (f=76 kHz, k=3 N/m) in tapping mode. As a baseline, the wear results for the samples were compared to that of the silicone resin alone on a glass substrate.

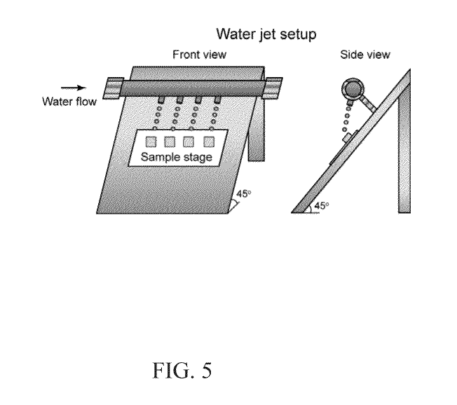

An established water jet procedure was performed to examine macroscale wear resistance of the samples in water flow. For applications involving self-cleaning glass, resistance to impingement of water is of critical interest. A schematic of the water jet setup is shown in FIG. 5. Samples were exposed to the water jet at different kinetic energy levels by varying the pressure of the water ejected from the nozzle. The samples were placed 2 cm below the four holes in the pipe, and the runoff plate was tilted at 45°. The exposure time was 20 min at each pressure. After each experiment, the CA and CAH of the samples were measured as described previously. The results for the coated samples were compared to a baseline sample of silicone resin alone on a glass substrate.

### Results

The nine types of transparent superhydrophobic samples using three different nanoparticles (SiO₂, ZnO, ITO) on three different substrates (glass, PC, PMMA) are discussed below. First, roughness values and surface morphology are presented. Then, the CA, CAH, and transmittance of samples are reported, discussing trends in the data. Lastly, the results of the wear resistance experiments are examined.

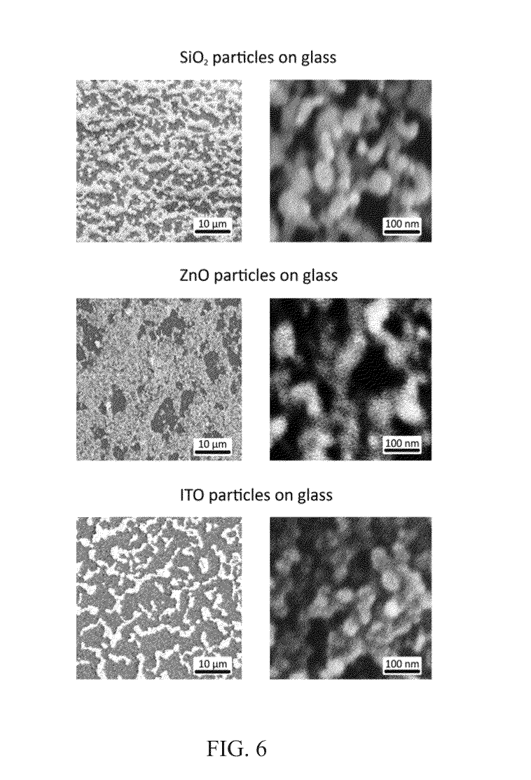

Table 1 displays RMS roughness, PV (peak-valley) distance, roughness factor (R_{f}), and coating thickness for samples with SiO₂, ZnO, and ITO. Surfaces had nanoscale roughness formed by nanoparticles bound to the substrate with silicone resin. The values of R_{f} were calculated using AFM surface height maps. By using the Z-height of each data point in the AFM scan matrix, the real surface area can be approximated using simple geometry. Dividing this value by the two-dimensional scan area provides R_{f}. Coating thicknesses were measured with a Tencor® stylus profiler on the step formed by partially coating a substrate, and found to be nearly equal to PV distance. FIG. 6 shows SEM micrographs of sample surfaces using each of the three nanoparticles on glass substrates at two magnifications. At lower magnification, the particles can be seen to form islands with a width on the order of a few microns. ZnO tended to cover more of the substrate, but less evenly and with larger pockets of uncoated area. ITO tended to coat the most evenly and with smallest islands. At higher magnification, individual nanoparticles can be seen forming roughness on the nanoscale, which suggests the particles are well-dispersed in solution. This multiscale roughness is desirable for superhydrophobicity.

TABLE 1
Measured roughness values (RMS, PV, and R_{f}), coating
thickness, and estimated liquid-air fractional area for
samples with SiO₂, ZnO, and ITO.

| Particles | | | | Coating | |
|---|---|---|---|---|---|
| on sample | RMS (nm) | PV (nm) | R_{f} | thickness (nm) | f_{LA} |
| SiO₂ | 58 ± 3 | 137 ± 5 | 1.5 | 150 ± 10 | 0.94 |
| ZnO | 84 | 191 | 1.8 | 205 | 0.94 |
| ITO | 45 | 127 | 1.3 | 135 | 0.91 |

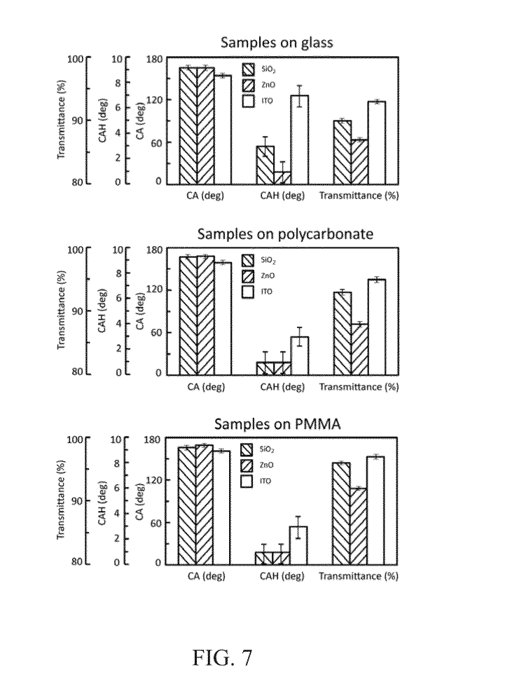

Data for samples using three different nanoparticles (SiO₂, ZnO, ITO) on three different substrates (glass, PC, PMMA) are shown in Table 2 (data shown graphically in FIG. 7). CA, CAH, and transmittance are reported for each of the nine sample types. All samples exhibited superhydrophobic, self-cleaning behavior, with CA nearly 170° and CAH as low as 1° in some cases. For all three particle types, CA was slightly higher on PC and PMMA substrates than on glass. CAH was slightly higher on glass substrates, except in the case of ZnO where it was unchanged at 1°. For all substrates, the samples with ITO particles had lower CA and higher CAH than those with SiO₂ and ZnO, although self-cleaning conditions were still met (CA>150° and CAH<10°).

TABLE 2
Wettability and transmittance data for all samples

| | Particle | | | | | | | | |
|---|---|---|---|---|---|---|---|---|---|
| | SiO₂ (55 nm) | | | ZnO (70 nm) | | | ITO (45 nm) | | |
| | (Silane modified) | | | (ODP modified) | | | (ODP modified) | | |
| Substrate | CA | CAH | T* | CA | CAH | T* | CA | CAH | T* |
| Glass (sodalime) | 165° | 3° | 90% | 165° | 1° | 87% | 154° | 7° | 93% |
| | (±2°) | (±1°) | (±0.25%) | | | | | | |
| Polycarbonate | 167° | 1° | 93% | 168° | 1° | 88% | 159° | 3° | 95% |
| PMMA | 166° | 1° | 96% | 169° | 1° | 92% | 161° | 3° | 97% |

*Average transmittance value across visible range (400-700 nm) as a percentage of the transmittance of the uncoated substrate

The Cassie-Baxter equation (Eq. 1) can be used to predict CA in the case where the droplet rests only on the highest asperities, with air filling gaps between:

cos θ=R_{f} cos θ₀−f_{LA}(R_{f} cos θ₀+1) (1)

where θ₀ is the CA on a flat surface of identical surface energy, and R_{f} (roughness factor) is the ratio of the real area of the interface to its two-dimensional projection. In the case of full wetting with no air pockets (Wenzel regime), CA can be predicted by simply setting f_{LA} equal to zero in Eq. 1. AFM surface maps were analyzed and f_{LA} values (shown in Table 1) were estimated to be 0.94, 0.94, and 0.91 for SiO₂, ZnO, and ITO samples, respectively. ITO nanoparticles tended to form more evenly distributed microscale islands with lower height distribution compared to SiO₂ and ZnO, possibly due in part to smaller primary particle size. In addition, CAH can be estimated by:

$$CAH \approx \frac{{R}_{f} \sqrt{1 - {f}_{LA}} ( cos {θ}_{rec 0} - cos {θ}_{adv 0} )}{ \sqrt{2 ( {R}_{f} cos {θ}_{0} + 1 )}} \qquad ( 2 )$$

where θ_{rec0} and θ_{adv0} are the flat-surface receding and advancing contact angles, respectively.

Table 3 shows measured and calculated CA and CAH values, with measured values taken from samples on glass substrates. Flat-surface angles (θ₀, θ_{rec0}, θ_{adv0}) were measured on a glass slide modified with the same ODP solution, and found to be θ₀=103°, θ_{rec0}=75°, and θ_{adv0}=132°. Comparison of the measured vales to calculated Wenzel and Cassie-Baxter values strongly suggests a Cassie-Baxter regime, especially given the very low CAH values measured, which are typically associated with Cassie-Baxter wetting. Thus, the droplet predominately contacts the highest peaks of the hydrophobic-modified nanoparticles. For CAH, Eq. 2 predicts essentially identical values of 0.3°, 0.4°, and 0.3° for SiO₂, ZnO, and ITO, respectively. The lower measured CA and higher CAH for ITO compared to calculated values may suggest that a small fraction of the droplet contacts the substrate for ITO samples, leading to partial Wenzel wetting and higher hysteresis. This may be a result of the topography of microsized islands for ITO samples, which tended to be smaller and with greater distance between. In the case that the droplet interface exhibits a small fraction of Wenzel wetting behavior, the hydrophobicity of the silicone resin (θ₀=99°) may help to preserve superhydrophobicity (CA>150°) and low CAH (<10°) necessary for self-cleaning behavior.

TABLE 3
Measured and calculated CA and CAH values for samples
with SiO₂, ZnO, and ITO nanoparticles. Measured values
are taken from samples on glass substrates.

| | | | CA calculated | | |
|---|---|---|---|---|---|
| | CA | CA calculated | using Cassie- | CAH | CAH |
| Particle | mea- | using Wenzel | Baxter equation | mea- | calculated |
| type | sured | equation | (Eq. 1) | sured | using Eq. 2 |
| SiO₂ | 165° | 110° | 164° | 3° | <1° |
| ZnO | 165° | 114° | 165° | 1° | <1° |
| ITO | 154° | 107° | 159° | 7° | <1° |

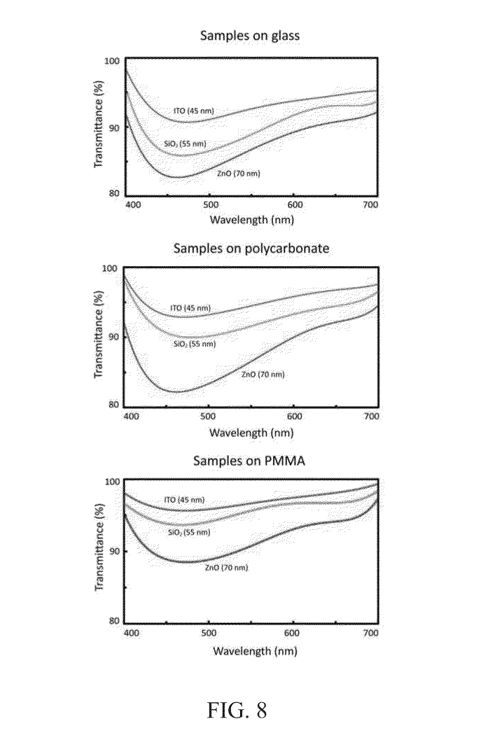

The uncoated glass, PC, and PMMA substrates had visible-range transmittances of 92%, 87%, and 94%, respectively. Transmittances of the samples are reported as percentages of the transmittance of the uncoated substrate. Table 2 shows the average values for samples across the visible spectrum (data shown graphically in FIG. 7). FIG. 8 shows transmittance data for SiO₂, ZnO, and ITO nanoparticles on all substrates. For all three particle types, samples on PMMA had higher transmittance than those on PC, and PC samples had higher transmittance than those on glass, even with transmittances normalized by substrate transmittance. For all substrates, the samples with ITO particles had higher transmittance than those with silica particles, and SiO₂ samples had higher transmittance than those with ZnO. The lower transmittance of the ZnO samples likely owes to their significantly higher roughness values compared to ITO and SiO₂. Conversely, the higher transmittance of the ITO samples likely owes to their lower roughness, comparatively. Despite somewhat less favorable values for band gap and refractive index, the ITO samples had higher transmittance than SiO₂ samples, which suggests that in this case, roughness and coating thickness played a larger role in transmittance than did inherent optical properties of particles. This may be due to the fact that roughness and coating thickness values were on the order of the 100 nm approximate threshold for visible transparency.

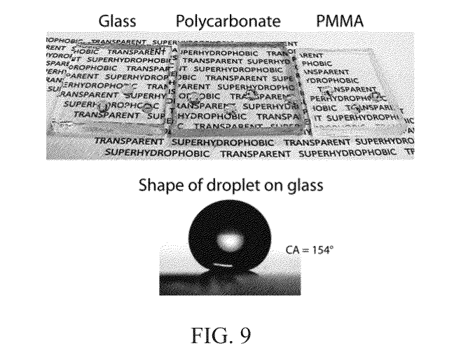

The transmittance of the samples in the context of coating thickness is in rough agreement with other published studies that have reported transmittance of greater than 90% for coating thickness of 380 nm using SiO₂/PDMS, and coating thickness of about 60 nm using SiO₂, respectively. Data for SiO₂ samples in these previous studies were intermediate, with transmittance values from 90-96% for coating thickness of 137 nm. Although very high transmittance values were achieved, an antireflective effect resulting in transmittance greater than 100% of the uncoated substrate, as reported in some studies, was not seen. In addition, the typical morphology of disconnected islands of particles, while beneficial for roughness and superhydrophobicity, disallows a path for electrical current. Further development of this technique would be necessary to prepare transparent, superhydrophobic coatings that are also electrically conductive. ITO-coated glass, PC, and PMMA samples with deposited water droplets can be seen in FIG. 9, showing superhydrophobicity and high transmittance of the coatings. Blue dye was added to water for visual clarity of droplets. Goniometer image of a droplet on ITO-coated glass is shown for better view of a superhydrophobic contact angle.

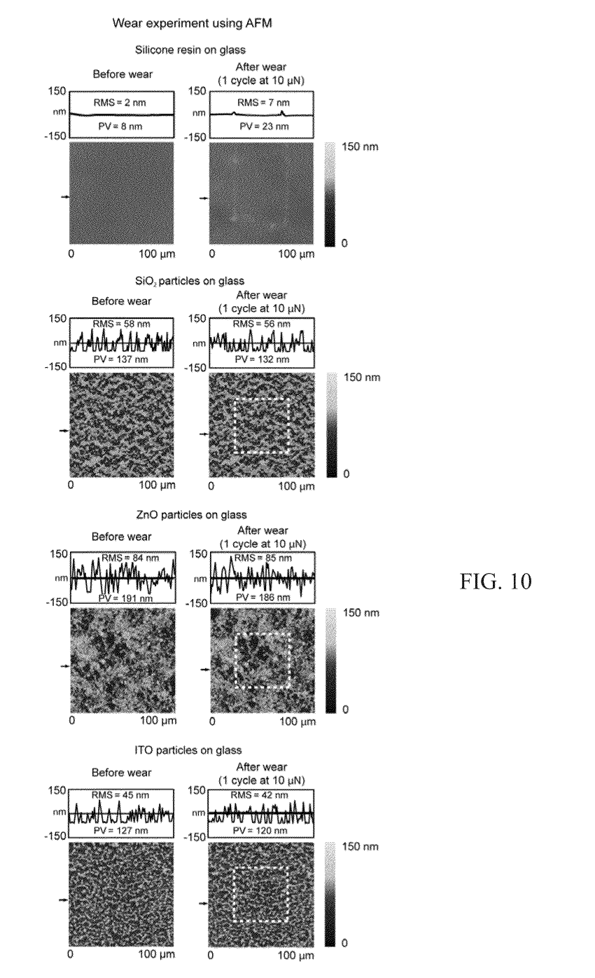

The results of the AFM wear experiment for SiO₂, ZnO, and ITO particles on glass as well as silicone resin alone on glass are shown in FIG. 10. Surface height maps before and after the wear experiment are displayed, as well as sample scans across the middle of the image (position indicated by arrow). Roughness values within the wear area (RMS and PV, before and after) are also displayed. Hardness of the silicone resin was measured with a microindenter (Micromet 3 Micro Hardness Tester) and found to be 1.3 GPa. The after-image of silicone resin alone reveals slight wear of the 50×50 μm² area worn by the borosilicate ball. The wear mode appears to be adhesive, as there is a fairly uniform removal of material. However, morphology was not significantly changed in the after-image for any of the three samples with nanoparticles, and RMS roughness and PV distance values remained similar. The minimal wear of the silicone resin and preservation of nearly identical roughness and surface morphology for samples indicates mechanical strength of the silicone resin, sufficient hardness of nanoparticles, and strong anchoring of particles in the silicone resin layer.

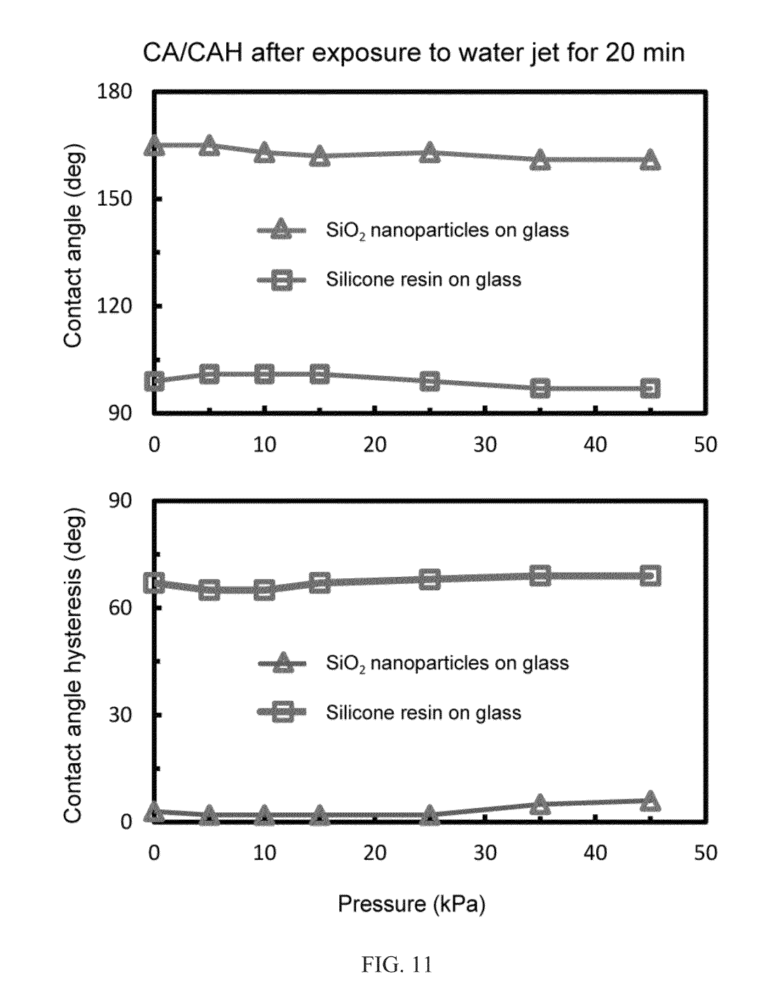

The results of the water jet experiment can be seen in FIG. 11. Samples were exposed to water jet for 20 min at each pressure ranging from 0 to 45 kPa. CA and CAH data are displayed for silica nanoparticles as well as silicone resin alone on glass substrates. For the samples with SiO₂ nanoparticles, superhydrophobicity and self-cleaning properties were maintained even at highest pressure, with CA decreasing from 165° to 160°, and CAH increasing from 3° to 6°. At some intermediate pressures, CAH as low as 1° was measured. The wettability of the samples with silicone resin was likewise not significantly changed, with CA of 97° at 45 kPa compared to an initial value of 99°. CAH for the silicone resin remained between 67° and 69° at all pressures. The results indicate wear resistance of the surfaces under impingement of water necessary for many self-cleaning applications.

The versatile dip coating techniques and coating solutions of the present disclosure were systematically shown to create transparent, superhydrophobic surfaces on glass and plastic substrates with SiO₂, ZnO, and ITO nanoparticles. ZnO and ITO particles were hydrophobized with ODP, and the prepared samples did not require post-treatment with low surface energy substances. The nanoparticles showed different tendencies in the way they deposited onto substrates from dip coating, which may be partly due to differences in primary particle size. This caused variation in coating thickness and morphology between particles, which helps to explain differences in wettability and transmittance between samples. ITO samples had slightly lower CA and slightly higher CAH than SiO₂, and ZnO, which is likely the result of a comparatively lower liquid-air fractional area (f_{LA}). Roughness and coating thickness seemed to influence transmittance more than inherent optical properties of particles, which may be due to the proximity of roughness and thickness values to the 100 nm threshold for visible transparency. Samples on PMMA substrates performed modestly better than those on PC and glass in terms of wettability and transmittance. However, all samples exhibited a superhydrophobic CA (>150°), low CAH (<10°), and high transmittance of visible light (>90% in most cases). In addition, all surfaces showed wear resistance for potential commercial use in AFM wear and water jet experiments, indicating strong bonding of the silicone resin and sufficient hardness of nanoparticles and resin.

Transparent superhydrophobic surfaces with wear resistance can be fabricated in accordance with principles of the present disclosure with a broad range of materials to expand potential engineering applications. However, primary particle size, roughness, and coating morphology appear to be at least as important a factor in transparency as inherent optical properties of the nanoparticles when coating thickness is on the order of 100 nm.

Methods in accordance with the present disclosure entail the dip coating of glass or polymer substrates in a solution containing hydrophobic nanoparticles, a resin binder, and a solvent. Samples were successfully created using silicon dioxide (SiO₂), zinc oxide (ZnO), and indium tin oxide (ITO) nanoparticles on soda-lime glass, polycarbonate (PC) and polymethyl methacrylate (PMMA) substrates with a methylphenyl silicone resin binder and solvent containing a mixture of tetrahydrofuran (THF) and isopropyl alcohol (IPA). Solution can be sonicated to improve dispersion. With appropriate solution concentrations and dip removal speed, superhydrophobic surfaces with high transmittance to visible light are obtained. Surfaces do not require post-fabrication treatment with low-surface-energy compounds, such as fluorosilanes, to achieve superhydrophobic effect.

Particle and resin binder concentrations and dip removal speed may vary based on particle type and size. Using silane-modified SiO₂ nanoparticles with average diameter ˜55 nm, useful concentrations were found to be approximately 10 mg/mL SiO₂ particles and 3.75 mg/mL methylphenyl silicone resin for a dip removal speed of 10 cm/min in some non-limiting embodiments.

The coated surfaces described here may be useful for applications involving self-cleaning windows/windshields, solar panels, or high performance optical devices, among others.

Although the present disclosure has been described with reference to preferred embodiments, workers skilled in the art will recognize that changes can be made in form and detail without departing from the spirit and scope of the present disclosure.

What is claimed is:

1. A method for forming a superhydrophobic, optically transparent coating on a surface of a substrate, the method comprising:
receiving a solution comprising hydrophobic nanoparticles, a resin binder, and a solvent;
dipping a substrate into the solution;
withdrawing the substrate from the solution, wherein as the substrate is withdrawn, a precursor coating of the solution remains on a surface of the substrate; and
allowing the solvent in the precursor coating to evaporate;
wherein immediately following the step of allowing the solvent to evaporate, the precursor coating transitions to a final, superhydrophobic, optically transparent coating bonded to the surface of the substrate.

2. The method of claim 1, wherein the method is characterized by the absence of post-treatment of the coating after the step of allowing the solvent to evaporate.

3. The method of claim 1, wherein the superhydrophobic, optically transparent coating exhibits a water contact angle of at least 150°.

4. The method of claim 1, wherein the superhydrophobic, optically transparent coating is at least 90% transmissive to visible light.

5. The method of claim 1, wherein the superhydrophobic, optically transparent coating has a thickness in the range of 50-150 nm.

6. The method of claim 1, wherein the substrate is glass.

7. The method of claim 1, wherein the substrate is a polymer.

8. The method of claim 7, wherein the substrate is selected from the group consisting of polycarbonate and polymethyl methacrylate.

9. The method of claim 1, wherein the hydrophobic nanoparticles are metal oxide nanoparticles surface functionalized to be hydrophobic.

10. The method of claim 9, wherein the metal oxide nanoparticles are selected from the group consisting of SiO₂, ZnO and ITO nanoparticles.

11. The method of claim 9, wherein the metal oxide nanoparticles are ITO nanoparticles.

12. The method of claim 1, wherein the solvent includes tetrahydrofuran (THF).

13. The method of claim 12, wherein the solvent is mixture of 30-49% THF and 51-70% isopropyl alcohol (IPA) by volume.

14. The method of claim 1, further comprising:
sonicating the solution during at least one of the steps of dipping the substrate and withdrawing the substrate.

15. The method of claim 1, wherein the step of withdrawing the substrate includes withdrawing the substrate from the solution at a rate in the range of 5-15 cm/min.

16. The method of claim 1, wherein the step of allowing the solvent to evaporate includes:
heating the precursor coating.

17. A solution for forming a superhydrophobic, optically transparent coating on a surface of a glass or polymer substrate, the solution comprising:
hydrophobic metal oxide nanoparticles;
a resin binder; and
a solvent;
wherein the solution is formulated to form a superhydrophobic, optically transparent coating on a surface of a glass or polymer substrate immediately following dip coating of the solution on to the surface and evaporation of the solvent.

18. The solution of claim 17, wherein the hydrophobic metal oxide nanoparticles are selected from the group consisting of functionalized SiO₂, ZnO, and ITO nanoparticles.

19. The solution of claim 18, wherein the hydrophobic metal oxide nanoparticles are functionalized ITO nanoparticles.

20. The solution of claim 17, wherein the hydrophobic metal oxide nanoparticles are functionalized SiO₂ nanoparticles, and further wherein a concentration of the SiO₂ nanoparticles in the solvent is in the range of 5-15 mg/mL.

21. The solution of claim 17, wherein the hydrophobic metal oxide nanoparticles are functionalized ZnO nanoparticles, and further wherein a concentration of the ZnO nanoparticles in the solvent is in the range of 25-45 mg/mL.

22. The solution of claim 17, wherein the hydrophobic metal oxide nanoparticles are functionalized ITO nanoparticles, and further wherein a concentration of the ITO nanoparticles in the solvent is in the range of 40-60 mg/mL.

23. The solution of claim 17, wherein the solvent includes tetrahydrofuran (THF).

24. The solution of claim 23, wherein the solvent is a mixture of 30-49% THF and 51-70% isopropyl alcohol (IPA) by volume.

25. The solution of claim 17, wherein the resin binder is a methylphenyl silicone resin.
